(19) United States
(12) Patent Application Publication
(10) Pub. No.: US 2020/0078952 A1
(43) Pub. Date: Mar. 12, 2020

(54) ROBOT MEMORY MANAGEMENT TECHNIQUES

(71) Applicant: MISTY ROBOTICS, INC., Boulder, CO (US)

(72) Inventors: Morgan Bell, Longmont, CO (US); Daniel H. Grollman, Boulder, CO (US)

(73) Assignee: MISTY ROBOTICS, INC., Boulder, CO (US)

(21) Appl. No.: 16/123,143

(22) Filed: Sep. 6, 2018

(51) Int. Cl. B25J 11/00; B25J 9/16; G06F 17/30

(52) U.S. Cl. CPC B25J 11/001; G06F 17/30734; B25J 9/163

(57) ABSTRACT

Aspects of the present disclosure generally relate to robot memory management techniques. In certain aspects, a robot generates a disposition representing a time slice of the robot's understanding of the world. The robot repeatedly generates new dispositions as time progresses, thereby updating entries within the disposition as changes occur over time. Changes are evaluated based on various thresholds or other criteria to determine whether to memorialize them for later reference. Memorialized changes are used to supplement a disposition, such that the disposition comprises not only current information, but also historical information. Similarly, a disposition is supplemented based on an ontology, such that objects and relationships of the ontology are used to identify instances of such objects and relationships within the disposition. As a result, the robot is able to recall historical information and to use ontological knowledge of the world to generate a richer view of the world.

### BACKGROUND

Robots typically process any of a variety of input data when generating outputs to interact with their surroundings. While traditional techniques may store historical data, such data are not often heavily processed to derive meaning and generate useable “memories” that may consequently affect the behavior of the robot either contemporaneously or in the future. Further, such processing proves difficult given the sheer amount of data that may be stored for subsequent use.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure generally relate to robot memory management techniques. In certain aspects, a robot generates a disposition representing a time slice of the robot's understanding of the world. The disposition comprises input data received or perceived by the robot, as well as output data generated by the robot. The robot repeatedly generates new dispositions as time progresses, thereby updating entries within the disposition as the input and/or output data changes over time. In order to memorialize changes, past dispositions are evaluated in view of the current disposition to identify changes. Changes may be evaluated based on various thresholds or other criteria to determine whether to memorialize them for later reference.

Accordingly, memorialized changes may be used to supplement a disposition, such that the disposition comprises not only current information, but also provides a historical perspective for a given disposition entry. Similarly, a disposition is supplemented based on an ontology, such that objects and relationships of the ontology are used to identify instances of such objects and relationships within the disposition. As a result, the robot is able to recall historical information for disposition entries and to use ontological knowledge of the world, thereby resulting in a richer view of the state of the world. The disposition may then be used to perform processing when generating outputs to engage in behaviors and react to stimuli in the world. Further, the memorialized information may also be used to ultimately affect the personality of the robot.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A depicts an example of a robotic device.

FIG. 1B depicts a more detailed depiction of an example of the control system in the robot.

FIG. 2 depicts an example of a method for robot memory generation.

FIG. 3A depicts an example disposition for a robot.

FIG. 3B depicts an example ontology for robot memory generation.

FIG. 4 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a robot has a variety of sensors, including, but not limited to, distance sensors, depth sensors, capacitive touch sensors, temperature sensors, image or optical sensors, and/or microphones. In such examples, input data (e.g., from the sensors, from a computing device, based on the robot's current state, etc.) is used to determine aspects of the robots behavior, such that the robot generates behaviors and responds to stimuli accordingly. However, as the robot processes inputs and generates various outputs, such data is typically not memorialized and managed in such a way so as to efficiently generate useable memories to subsequently affect the processing and associated behavior of the robot. Further, determining which aspects of the input and/or output data should be stored is difficult, especially as the amount of data available for processing and potential storage increases.

Accordingly, the present disclosure provides systems and methods for robot memory management techniques. In an example, a robot generates a disposition based on its input and output data, such that the disposition represents the current state of the robot and its perception of the world. Entries in the disposition may be supplemented based on stored information, which, as a result, may affect the current state and/or future outputs of the robot. In examples, the disposition is generated periodically (e.g., every tenth of a second, every second, etc.), in response to the occurrence of an event, or when input data is received from one or more sensors, among other examples, to incorporate changes in both the input and output data over time. As such, a series of dispositions may constitute an “experience” for the robot, comprising the sequence of inputs and outputs for the robot over a period of time. A current disposition is compared to one or more previous dispositions to determine whether any entries of the current disposition have changed. If a change is identified, the change may be evaluated based on a threshold to determine whether information associated with the change should be memorialized, thereby forming a memory of the robot. Such memorialized information may later be used to supplement a subsequent disposition (e.g., as a part of the stored information used to supplement a disposition entry), used to generate a causal relationship between an output of the robot and one or more perceived inputs, or used to evaluate a current disposition entry, among other uses. As a result, the robot is able to memorialize a certain subset of its input and/or output data, thereby reducing the amount of data that needs to be processed and stored, while still making such data accessible for later processing.

An example disposition represents the robot's current perception of the world, such that it comprises information representing a time slice of the current state of a robot. The disposition is generated based on input data and output data for the robot. In examples, such data is processed prior to incorporation into the disposition, while, in other examples, raw data may be incorporated into the disposition. For example, image data from a camera is processed to identify one or more world objects, which are then correlated with depth data received from a depth sensor to determine the spatial location of the identified world objects. In an example, a disposition comprises information relating to a state of the robot (e.g., the charge state of a battery, the location of the robot, the affective state of the robot, etc.), perceived characteristics of the world (e.g., temperature, humidity, time, brightness, weather, etc.), information relating to one or more world objects (e.g., humans, pets, furniture, obstacles, etc.), and/or information relating to the current outputs of the robot (e.g., a facial expression, spoken text, movements, etc.), among other information.

Given that a disposition represents a time slice of a robot's current state, a current disposition may be compared to previous dispositions to identify changes and to determine whether such changes should be memorialized. For example, one or more previous dispositions are retained for comparison when a new disposition is generated. Different thresholds may be used to evaluate different changes. As an example, certain changes are memorialized when they occur regardless of the extent to which they are different as compared to previous dispositions. In another example, a change is memorialized only if it differs as compared to a previous disposition by a certain threshold value or if it exceeds a certain range, etc. In a further example, a change is memorialized based on determining whether the disposition entry has or has not changed within a certain time window and optionally memorializing that fact.

In examples, entries in the disposition are supplemented based on stored information, including, but not limited to, one or more ontologies and information that was previously memorialized according to aspects disclosed herein. Accordingly, the disposition may further comprise historical or memorialized information, as well as properties and/or relationships that may be imputed to disposition entries based on one or more ontologies. Thus, the disposition not only stores information relating to the robot's current perception of the world, but also enables the robot to have a deeper understanding of the world, with respect to what properties an object has or can have, how objects are interrelated, and how the world changes over time.

An ontology comprises a set of objects and relationships, each of which may have one or more associated properties. In an example, the ontology is predefined (e.g., preinstalled on the robot, downloaded or accessed from a computing device, etc.) and/or is dynamically generated or updated by the robot. Accordingly, the ontology is used to identify disposition entries as instances of objects in the ontology. As a result of identifying a disposition entry as an ontology object, properties associated with the ontology object are imputed to the disposition entry. For example, if the ontology comprises an object representing a chair, the chair ontology object may have properties relating to the type of chair and number of legs, among other properties. Thus, if a world object is identified as an instance of a chair ontology object, the robot may populate the properties of the chair world object (e.g., the type of the chair, the number of legs, etc.) without needing to first receive or access additional information relating to the chair in the world. Similarly, the ontology may indicate one or more relationships associated with a chair object, such as an “occupant” relationship with a “human” object. For example, if a second world object is identified as being on top of the chair, it may be discerned that the second world object is a human object, and that an “occupant” relationship exists between the chair world object and the human world object. While example ontologies, objects, and relationships are described, it will be appreciated that other examples may be used according to aspects disclosed herein.

In another example, disposition entries are supplemented based on memorialized information. For example, the memorialized information stores historical information for one or more properties of an instantiated object, such that changes of object properties over time are accessible via the disposition. For instance, the memorialized information may store historical temperatures observed by a temperature sensor, such that a current disposition entry for the temperature sensor may be supplemented based on the historical information. In some examples, only a certain number of historical observations are used to supplement the disposition. In other examples, historical observations from a certain time window are used to supplement the disposition. It will be appreciated that other criteria may be used to determine which subset of historical information should be used to supplement a disposition.

As a result of generating such dispositions and memorializing changes observed in disposition entries over time, the robot may generate causal relationships between outputs and inputs, thereby forming a feedback loop by which the robot's personality and/or behavior are adjusted based on such causal relationships. In other examples, the memorialized information may be incorporated into subsequently generated dispositions as described above, such that the robot has a memory from which to access historical information when performing subsequent processing, thereby enabling the robot to observe how the world changes over time. Further, as the robot identifies instances of ontology objects within dispositions and imputing properties and relationships accordingly, the robot is able to generate an understanding as to how perceived objects are interrelated.

A variety of technical benefits are realized by aspects described herein. For example, as a result of memorializing information to identify meaningful disposition changes when they occur (e.g., based on thresholds, time windows, etc.), the storage requirements necessary to store historical information generated by the robot may be reduced as compared to storing most, if not all, data generated by a robot. Further, even in instances where data is selectively stored, the disclosed threshold-based analysis ensures that the information that is stored is relevant to informing the behavior of the robot in the future. As a result of reducing the quantity and improving the quality and relevance of the memorialized information, the amount of processing necessary to utilize such information may similarly be reduced.

In addition, implementing techniques to supplement a disposition using memorialized information and ontology information enables a robot to generate and maintain a deeper understanding of the world without necessitating complex definitions of rules and implementation logic. Rather, according to aspects described herein, it is possible for the robot to efficiently identify historical trends and anomalies, ontological relationships between objects in the world, and infer properties without definitively detecting or determining such properties beforehand. As a result, such relationships and properties need not be hardcoded into the robot, resulting in a robot that is more dynamic and adaptable without explicitly programming the robot to operate in many different predetermined environments. Further, behavior generation is more responsive and better tuned to the surroundings of the robot, thereby improving the user experience provided by the robot. While example benefits are described herein, it will be appreciated that such examples are not exclusive and additional benefits are provided by aspects described herein. Further, it will be appreciated that similar techniques are applicable to any of a variety of other computing devices, including, but not limited to, a laptop, a mobile phone, or a tablet device. In some instances, such a computing device may provide a virtual assistant implementing techniques described herein.

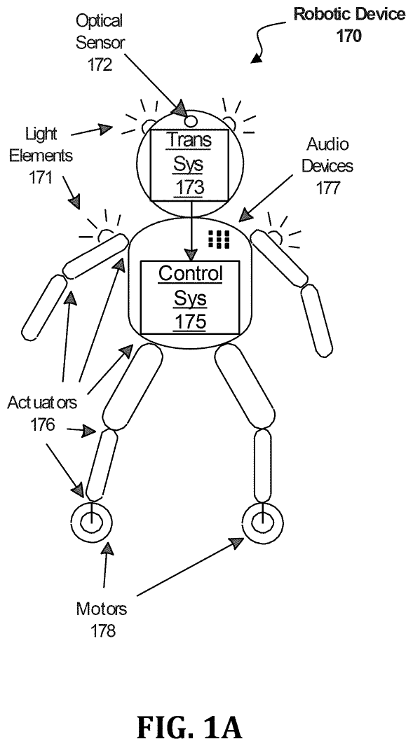

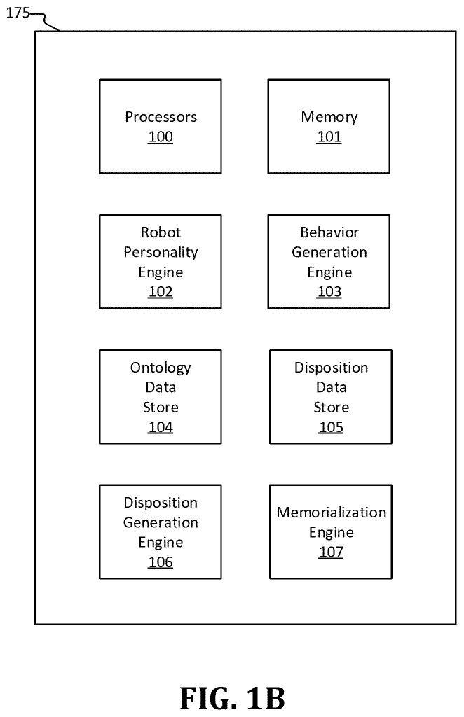

FIG. 1A depicts an example of a robotic device 170. The terms “robotic device” and “robot” are used interchangeably herein. Further, it will be appreciated that while examples herein are described with respect to a robot, similar techniques may be utilized by any of a wide array of other computing devices, including, but not limited to, personal computing devices, desktop computing devices, mobile computing devices, and distributed computing devices.

The robotic device 170 can move in a plurality of manners and can provide feedback through a variety of output mechanisms, so as to convey expressions. For example, the robotic device 170 may include light elements 171 and audio devices 177. The light elements 171 may include LEDs or other lights, as well as displays for displaying videos or other graphical items. The audio devices 177 may include speakers to provide audio output from the robot 170. A plurality of actuators 176 and motors 178 may also be included in the robot 170 to allow the robot to move as a form of communication or in response to user input. In addition, a plurality of input devices may also be included in the robot 170. For example, the audio devices 177 may also include a microphone to receive sound inputs. An optical sensor 172, such as a camera, may also be incorporated into the robot 170 to receive images or other optical signals as inputs. Other sensors, such as accelerometers, GPS units, thermometers, timers, altimeters, or any other sensor, may also be incorporated in the robot 170 to allow for any additional inputs that may be desired.

The robot 170 may also include a transmission system 173 and a control system 175. The transmission system 173 includes components and circuitry for transmitting data to the robot from an external device and transmitting data from the robot to an external device. Such data transmission allows for programming of the robot 170 and for controlling the robot 170 through a remote control or app on a smartphone, tablet, or other external device. In some examples, inputs may be received through the external device and transmitted to the robot 170. In other examples, the robot 170 may use the transmission system 173 to communicate with an external device over a network (e.g., a local area network, a wide area network, the Internet, etc.). As an example, the robot 170 may communicate with an external device that is part of a cloud computing platform. The control system 175 includes components for controlling the actions of the robot 170. In some examples, the control system 175 comprises components for engaging in robot memory management, according to aspects disclosed herein.

FIG. 1B depicts a more detailed depiction of an example of the control system 175 in the robot 170. The control system 175 includes one or more processors 100 and a memory 101 operatively or communicatively coupled to the one or more processors 100. The one or more processors 100 are configured to execute operations, programs, or computer executable instructions stored in the memory 101. The one or more processors 100 may be operable to execute instructions in accordance with the robot memory management technology described herein. Memory 101 may be volatile memory (such as RAM), non-volatile memory (such as ROM, flash memory, etc.), or some combination of the two. Memory 101 may comprise computer storage media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. In one example, memory 101 is operable to store instructions for executing methods or operations in accordance with aspects described herein. The instructions may be stored as software or firmware in the control system 175.

The control system 175 also includes a robot personality engine 102, a behavior generation engine 103, an ontology data store 104, a disposition data store 105, a disposition generation engine 106, and a memorialization engine 107. It will be appreciated that the functionality described herein with respect to the control system 175 and other aspects of the robot 170 may be provided at least in part by an external device, in some examples.

In an example, a personality for the robot 170 may be defined by robot personality engine 102 as a personality location within a unidimensional or multidimensional personality space, which may be associated with one or more factors (e.g., dimensions). As an example, dimensions of a personality space may comprise factors relating to openness, conscientiousness, agreeableness, extrovertedness, and neuroticism. In some instances, the personality of the robot 170 may be adjusted. As an example, the robot personality engine 102 may adjust the personality of a robot based upon memorialized information according to aspects disclosed herein. Such information may be related to interactions with a user, environmental conditions, and actions performed by the robot, among other information. As an example, the robot 170 may initially have little or no understanding of good and bad behavior. Accordingly, a user may provide positive reinforcement to a robot in order to encourage perceived good behavior and/or negative reinforcement to discourage perceived bad behavior, which may eventually cause the personality location of the robot to shift within the personality space, thereby adjusting the personality of the robot. Thus, the robot 170 may gain an understanding of good and bad behavior based on, among other things, its interactions with the user.

The behavior generation engine 103 may be used to generate behaviors for the robot 170. In an example, the robot's behavior is generated in response to receiving input or based on a current goal for the robot (e.g., an activity that the robot is to perform, resulting from an affective state, etc.), among other reasons. For example, upon receiving input indicative of an interaction with a user, the behavior generation engine 103 may determine a response to the received input. While example robot personality and behavior generation techniques are briefly discussed, it will be appreciated that any of a variety of other techniques may be used. Aspects of robot personality and behavior generation are also discussed in U.S. patent application Ser. No. 15/818,133, titled “INFINITE ROBOT PERSONALITIES,” the entirety of which is hereby incorporated by reference in its entirety.

As illustrated, the control system 175 further comprises an ontology data store 104. In examples, ontology data store 104 comprises one or more ontologies describing interrelated objects, as discussed above. In one example, ontology data store 104 stores an ontology that is preinstalled on and/or downloaded to the robot 170. In another example, ontology data store 104 stores an ontology that was generated by the robot 170 and/or another computing device. In some examples, an ontology stored by ontology data store 104 is dynamically updated over time (e.g., by the robot 170, by another computing device, etc.) as the robot 170 experiences additional interactions and/or encounters more world objects.

The control system 175 is illustrated as further comprising a disposition data store 105. In an example, the disposition data store 105 stores a current disposition, as may be generated by disposition generation engine 106 discussed below. In another example, the disposition data store 105 stores one or more previous dispositions, such that the current disposition may be compared to one or more previous dispositions in order to determine whether any disposition entries have changed. In some examples, the disposition data store 105 stores memorialized information as may be generated by memorialization engine 107 described below. Accordingly, information from the ontology data store 104 and/or disposition data store 105 comprises stored information, which may be used to supplement a current disposition.

The disposition generation engine 106 generates dispositions representing the current state of the robot 170 based on input data and/or output data. In examples, the disposition generation engine 106 generates a disposition periodically (e.g., every tenth of a second, every second, etc.), in response to the occurrence of an event, or when input data is received from one or more sensors, among other examples. In an example, a disposition comprises information relating to a state of the robot, perceived characteristics of the world, and/or information relating to one or more world objects, among other information. In another example, a disposition comprises information relating to the current outputs of the robot, as may be generated by behavior generation engine 103. As described above, the information used by the disposition generation engine 106 to generate the disposition may be raw (e.g., raw sensor data, raw memory content, etc.) and/or may be processed (e.g., recognized world objects, serialized data objects, etc.).

In examples, the disposition generation engine 106 supplements disposition entries of the disposition based on stored information. For example, the disposition generation engine 106 uses one or more ontologies stored by the ontology data store 104 and/or past dispositions and memorialized information from the disposition data store 105. As another example, the disposition generation engine 106 may access stored information from another computing device in addition to or as an alternative to the stored information of the control system 175.

An ontology from ontology data store 104 may be used to associate disposition entries with objects in the ontology. As a result of identifying a disposition entry as an ontology object, properties associated with the ontology object are imputed to the disposition entry. Similarly, the ontology may comprise one or more relationships interrelating objects of the ontology, which may similarly be used by disposition generation engine 106 to supplement disposition entries. In examples, a classifier is trained to identify objects within the ontology, such that the classifier may be used to identify such ontology objects in order to associate them with disposition entries accordingly. In other examples, a set of attributes associated with a disposition entry may be evaluated based on a set of attributes for an ontology object to determine whether the disposition entry and ontology object have similar attributes. For instance, if a disposition entry has attributes that indicate it is round and has a number and a color, the disposition entry may be matched with an ontology object having similar attributes, such as a billiards ball. While example techniques for matching disposition entries and ontology entries are described, it will be appreciated that other techniques may be used.

In another example, the disposition generation engine 106 uses memorialized information from the disposition data store 105 to supplement the generated disposition. For example, the disposition data store 105 may incorporate memorialized information relating to changed object properties in order to supplement the disposition. As a result, disposition entries of the generated disposition may provide a historical record of changes that may be used when the robot 170 generates outputs (e.g., as may be generated by behavior generation engine 103). In some examples, only a certain number of historical observations are used to supplement the disposition. In other examples, historical observations from a certain time window are used to supplement the disposition. It will be appreciated that other criteria may be used to determine which subset of historical information should be used to supplement a disposition. Memorialized information may be matched to disposition entries using similar techniques as were described above with respect to identifying ontology entries, including, but not limited to, using a trained classifier and/or evaluating attributes associated with the disposition entries and memorialized information. In another example, a unique identifier may be generated for a disposition entry, such that the unique identifier may be used to identify relevant historical information from disposition data store 105. For example, a hash function may be used to generate the unique identifier based on attributes associated with the disposition entry. Other techniques include, but are not limited to, correlating disposition entries with memorialized information based on time, location in space, or manual correlations specified by a user.

The memorialization engine 107 of the control system 175 compares a current disposition generated by disposition generation engine 106 with one or more previously generated dispositions (e.g., as may be stored by disposition data store 105) to identify changes and determine whether such changes should be memorialized. In examples, different thresholds and/or other criteria are used to evaluate changes between the dispositions. As an example, certain changes are memorialized when they occur regardless of the extent to which they are different as compared to previous dispositions. In another example, a change is memorialized only if it differs as compared to a previous disposition by a certain threshold value or if it exceeds a certain range, etc. In a further example, a change is memorialized based on determining whether the disposition entry has or has not changed within a certain time window and optionally memorializing that fact. In examples, the memorialized information is stored by disposition data store 105.

In some examples, memorialization engine 107 operates relatively concurrently with disposition generation engine 106, such that newly generated dispositions are processed to identify changes in substantially real time. In other examples, memorialization engine 107 performs post hoc processing of stored dispositions in disposition data store 105. In such examples, rather than contemporaneously memorializing information, the robot 170 periodically processes stored dispositions and memorialize information accordingly. For example, the memorialization process may occur while the robot is idle or charging, among other examples. In another example, the robot 170 implements a hybrid technique, wherein a first set of dispositions are analyzed for memorialization contemporaneously, while a second set of dispositions are analyzed at a later time. While examples are described herein with respect to the processing occurring on the robot 170 by the control system 175, it will be appreciated that some or all of the processing may be performed by another computing device. While FIGS. 1A-1B are described in the context of robot 170, it will be appreciated that similar techniques and components are applicable to any of a variety of other computing devices, such as a computing device providing a virtual assistant.

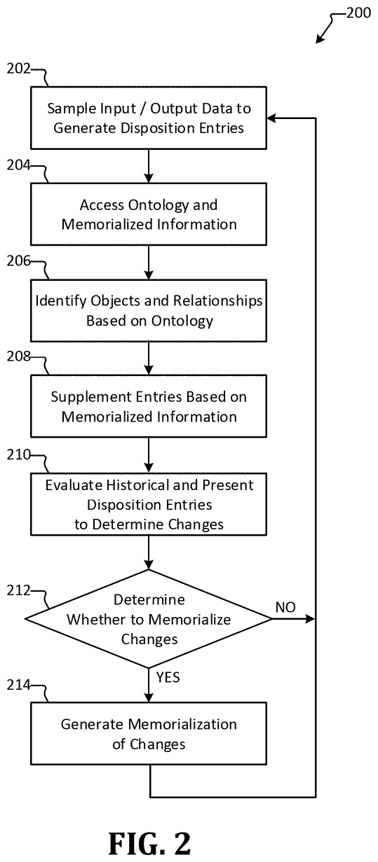

FIG. 2 depicts an example of a method 200 for robot memory generation. In an example, aspects of the method 200 are executed or otherwise performed by a memorialization engine, such as the memorialization engine 107 in FIG. 1B. In another example, some aspects of the method 200 are performed substantially contemporaneously with disposition generation or, in other examples, various aspects are performed after such generation and may be based at least in part on stored dispositions. As described above, such memorialization techniques may reduce the amount of data stored by the robot and may increase the relevance of the stored information, thereby reducing the storage requirements and processing requirements according to aspects described herein. In addition to a robotic device, aspects of method 200 are similarly applicable to any of a variety of other computing devices, such as a computing device providing a virtual assistant.

The method 200 begins at operation 202, wherein input data and/or output data is sampled to generate one or more disposition entries for a disposition. As described herein, disposition entries based on input data may relate to a state of the robot (e.g., the charge state of a battery, the location of the robot, the affective state of the robot, etc.), perceived characteristics of the world (e.g., temperature, humidity, time, brightness, weather, etc.), and/or information relating to one or more world objects (e.g., humans, pets, furniture, obstacles, etc.), among other information. In another example, disposition entries based on output data relate to the current outputs of the robot (e.g., a facial expression, spoken text, movements, etc.). It will be appreciated that a disposition may comprise disposition entries relating to input data, output data, or a combination thereof In an example, raw data may be sampled, while, in other examples, the raw data may be processed prior to incorporation into the disposition.

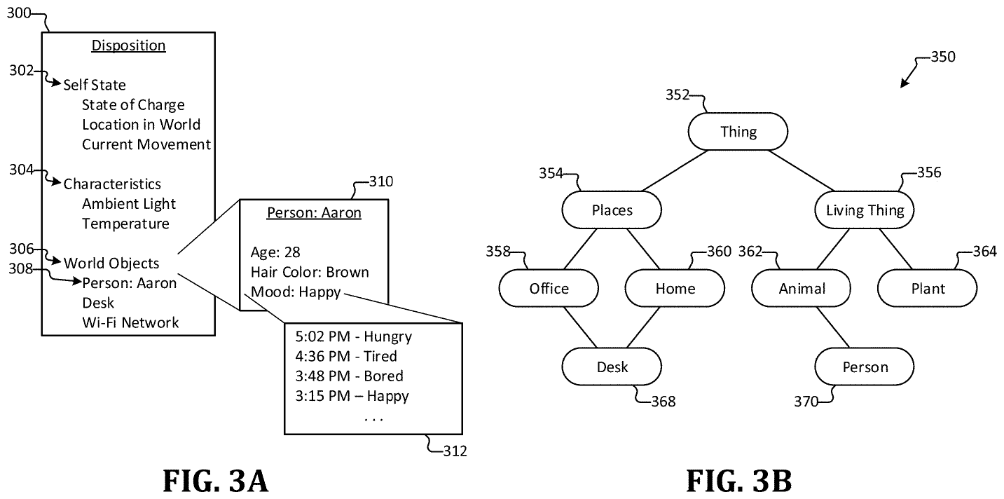

At operation 204, an ontology and memorialized information is accessed. In some examples, the ontology is accessed from an ontology data store, such as the ontology data store 104 in FIG. 1B. The ontology may be previously installed on or downloaded to the robot, may be dynamically generated, and/or may be accessed from another computing device, among other examples. An example ontology is discussed below with respect to FIG. 3B. Memorialized information is also accessed. In an example, the memorialized information is accessed from a disposition data store, such as disposition data store 105 in FIG. 1B. As described above, the memorialized information may comprise historical information associated with one or more disposition entries. Operation 204 is described with respect to accessing an ontology and memorialized information, but it will be appreciated that other stored information may be used in addition to or as an alternative to such examples.

Flow progresses to operation 206, where objects and/or relationships are identified within the disposition entries based on the accessed ontology. As described above, an ontology comprises a set of objects and relationships. Instances of such ontology objects are identified within the disposition entries as described above, such that properties associated with the ontology objects are imputed to the disposition entries. Similarly, instances of relationships are identified based on the identified objects and the relationships described by the ontology. As a result of supplementing disposition entries based on the ontology, it is possible to generate a deeper understanding of the world without first definitively determining or detecting such information. This may enable a robotic device to generate more relevant and more dynamic behaviors based on its surroundings, among other benefits. While method 200 is described with respect to a single ontology, it will be appreciated that multiple ontologies may be accessed and used to identify such objects and/or relationships. As an example, a user may indicate that the robot should download a variety of specific ontologies, wherein each ontology relates to a specific body of knowledge (e.g., a house object ontology, an outside object ontology, an animal ontology, etc.).

At operation 208, disposition entries are supplemented based on the memorialized information, thereby generating supplemented disposition entries. For example, memorialized information may comprise historical information for a disposition entry, such that the historical information may be associated with the disposition entry so as to make such historical information easily accessible and more readily available when processing the disposition. As a result, not only does the generated disposition comprise the disposition entries for a time slice representing the current state, but the disposition entries are associated with historical information, thereby enabling a robot to use the disposition to identify historical trends and perform subsequent processing based not only on current data, but on past data as well.

Moving to operation 210, historical and present disposition entries are evaluated to determine changes. As described above, historical dispositions may be accessed from a disposition data store, such as the disposition data store 105 in FIG. 1B. The evaluation may comprise evaluating a certain number of historical dispositions and/or historical dispositions from a certain time window, among other criteria. Changes may be identified by comparing similar and/or the same disposition entries to determine whether the information associated with each entry has changed. In some examples, a disposition entry is identified based on a unique identifier, such that the entry from a historical disposition may be matched to the entry in a current disposition.

At determination 212, it is determined whether to memorialize the identified changes. In examples, the determination comprises applying different thresholds and/or other criteria to different entries. For example, certain changes are memorialized when they occur regardless of the extent to which they are different as compared to previous dispositions. In another example, a change is memorialized only if it differs as compared to a previous disposition by a certain threshold value or if it exceeds a certain range, etc. In a further example, a change is memorialized based on determining whether the disposition entry has or has not changed within a certain time window and optionally memorializing that fact. As a result of performing such an analysis, the information that is memorialized is more relevant as compared to storing most, if not all, of such information. This enables a potential reduction in the storage and processing requirements of such memorialized information.

If it is determined to memorialize at least some of the changes identified at operation 210, flow branches YES to operation 214, where a memorialization of the changes is generated. In an example, memorialization information is generated for each of the changes that are determined to be memorialized. Memorialization information may comprise information relating to the identified change (e.g., the previous value, the current value, etc.), information relating to the disposition entry (e.g., a unique identifier, a specific object to which the change relates, etc.), and/or a timestamp, among other information. As described above, the memorialization information may be stored in a disposition data store of the robot and/or another computing device. In other examples, the memorialization information may be provided to another computing device for additional processing and/or storage.

If, however, it is determined not to memorialize the identified changes, flow instead branches NO, such that flow returns to operation 202. Flow is similarly illustrated as returning to operation 202 after operation 214. Accordingly, flow loops through operations 202-214 as new dispositions are generated according to aspects disclosed herein. For example, a disposition is generated periodically, in response to the occurrence of an event, or when input data is received from one or more sensors, among other examples. It will be appreciated that, in some aspects, not all operations are performed for each loop. For example, supplemented disposition entries may be retained, copied, or referenced, such that operations 204-208 may not be performed at each refresh for every disposition entry, thereby reducing the amount of processing required that is utilized when generating the current disposition entry.

FIG. 3A depicts an example disposition 300 for robot memory. In an example, disposition 300 is generated by performing aspects of method 200, as was described above with respect to FIG. 2. Disposition 300 may be for a robot, such as the robot 170 in FIGS. 1A-1B. Disposition 300 may be updated periodically according to aspects disclosed herein, and may be similarly applicable to any of a variety of other computing devices.

Disposition 300 comprises a self state 302, characteristics 304, and world objects 306. As illustrated, the self state 302 comprises a state of charge for a battery of the robot, a location in the world for the robot, and a current movement being performed by the robot. Thus, the self state 302 represents a variety of current attributes associated with the robot, which may comprise both input data (e.g., state of change, location in world, etc.) and output data (e.g., current movement, etc.). Characteristics 304 is illustrated as comprising ambient light and temperature. In examples, the entry may comprise raw data (e.g., directly from the temperature sensor) or may comprise processed data (e.g., an ambient light percentage based on known maxima and minima associated with the current location of the robot). World objects 306 comprises a listing of world objects identified by the robot (e.g., as a result of processing visual data in combination with depth data, as a result of receiving a listing from another computing device, among other identification techniques). Specifically, world objects 306 comprises a person 308 (“Aaron”), a desk, and a Wi-Fi network. It will be appreciated that disposition 300 is described with respect to example data and that additional, fewer, and/or alternative data may be incorporated into a disposition.

Person object 310 is provided as an example of supplemental information that is associated with the person 308 in the disposition 300. In an example, person object 310 is generated by performing some aspects of the method 200 in FIG. 2, such that stored information is accessed and used to supplement the disposition 300. For example, an ontology (e.g., ontology 350 in FIG. 3B) comprises a person object having a set of properties. As a result of identifying person 308 as an instance of the person ontology object, such properties are imputed and used to generate person object 310. Specifically, the person ontology object comprises an “age” property, a “hair color” property, and a “mood” property, such that the properties associated with the person 308 maybe populated by the robot. As illustrated, person object 310 is for Aaron, who has an age of 28, a hair color of brown, and a current mood of happy. In some examples, the information used to populate the properties may be accessed from a data store, may be determined based on input data, or may be determined based on relationships identified within the disposition 300, among other techniques.

The person object 310 is illustrated as further comprising memorialized information 312, wherein mood changes of Aaron have been memorialized according to aspects described herein. As illustrated, Aaron's moods and times at which mood changes were identified have been memorialized and used to supplement the person object of the disposition 300. As a result, when the robot performs processing and generates subsequent outputs, it is able to access a historical record of Aaron's moods, which is useful in generating relationships between the robot's actions (e.g., if the robot brought food to Aaron, thereby transforming his mood from “Hungry” at 5:02 PM to his current mood of “Happy”) and adapting the robots personality accordingly, among other uses. It will be appreciated that mood is offered as an example, and memorialized information may be used to provide any of a variety of historical supplemental information for disposition entries.

FIG. 3B depicts an example ontology 350 for robot memory generation. In examples, an ontology comprises a hierarchical structure of objects, wherein objects lower in the hierarchy may inherit properties of the objects from which they descend. As an example, a living thing object 356 may have an age property, such that all descendant objects (objects 362, 364, and 370) may similarly have an age property. Such properties may be required, thereby indicating that all instances of an object has such properties, or, in other examples, may be properties that instances of an object are only likely to or may occasionally have. Similarly, a places object 354 may have an “occupant” relationship that is inherited by descendant places, such as office object 358, home object 360 and desk object 368. Accordingly, the “occupant” relationship may be used in conjunction with any such places object 354 to indicate that a living thing object 356 is at that place. Thus, an ontology also contains definitions for how objects within the ontology are related. Further, an ontology may declare objects are not the same (e.g., dog is not cat, desk is not chair, etc.). In some instances, an ontology may define the individuality of something, such as an ownership relationship between an instance of a person object and an instance of an animal object.

The desk object 368 is illustrated as descending from both office object 358 and home object 360, thereby indicating that the desk object 368 may exist in both an office or a home. In some instances, a robot may traverse such an ontology to determine an object that is the closest match for a disposition entry, among other identification techniques described above. As an example, the robot may determine that a thing is living, and therefore is likely to be a living thing object 356 or one of its descendants. Similarly, the robot may distinguish an animal object 362 from a plant object 364, and may subsequently determine whether the object is a person object 370.

In another example, a robot generates additional objects within an ontology. For example, the robot may identify that an object is a living thing object 356, but may not know what type. Accordingly, the robot may request user input (e.g., verbally, via another computing device, etc.) of a specific type of living object, such that the ontology 350 may be modified to incorporate a new object descending from the living thing object 356. In other examples, a user may modify an ontology or may define a new ontology using a computing device and/or an interface made available by the robot. While ontology 350 is illustrated as having a hierarchical structure, it will be appreciated that other organizational structures may be used to interrelate objects of an ontology.

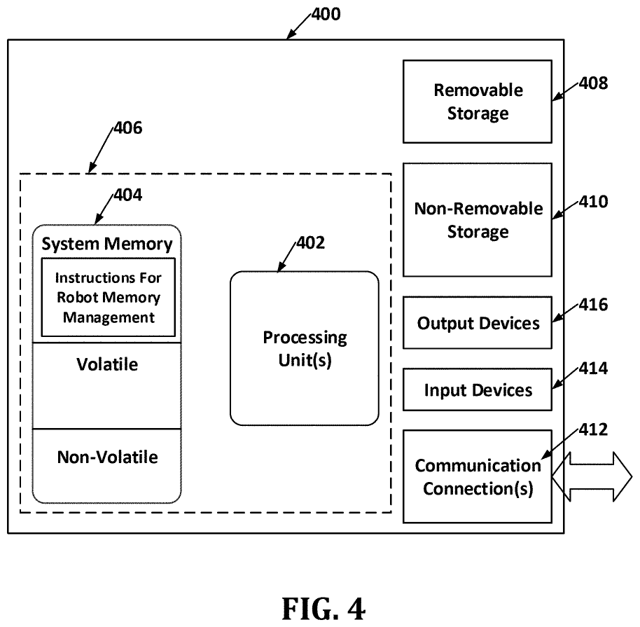

FIG. 4 illustrates another example of a suitable operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically includes at least one processing unit 402 and memory 404. Depending on the exact configuration and type of computing device, memory 404 (instructions to perform robot memory management techniques as described herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a robotic device comprising: at least one processor; and memory encoding computer executable instructions that, when executed by the at least one processor, perform a method. The method comprises: generating, based on input data and output data associated with the robotic device, a disposition comprising one or more disposition entries; supplementing at least one disposition entry of the one or more disposition entries based on stored information to generate a supplemented disposition entry, wherein the stored information is at least one of an ontology or memorialized information; generating a behavior for the robotic device based at least in part on the supplemented disposition entry; and causing the robotic device to perform the generated behavior. In an example, the method further comprises: evaluating the generated disposition based on a previously generated disposition to identify one or more changed disposition entries; determining, based on a threshold, whether to memorialize a changed disposition entry of the one or more changed disposition entries; when it is determined to memorialize the changed disposition entry, generating memorialized information associated with the changed disposition entry; and storing the generated memorialized information. In another example, supplementing the at least one disposition entry based on stored information comprises: accessing an ontology; determining that the at least one disposition entry is an instance of an object of the ontology; and associating at least one property of the object of the ontology with the at least one disposition entry in the generated disposition. In a further example, supplementing the at least one disposition entry based on stored information comprises: accessing memorialized information for the robotic device; determining that at least a part of the memorialized information comprises historical information relating to the at least one disposition entry; and associating the historical information with the at least one disposition entry in the generated disposition. In yet another example, associating the historical information with the at least one disposition entry comprises associating only a subpart of the historical information, wherein the subpart is determined based at least in part on either: a quantity associated with the historical information; or a time window associated with the historical information. In a further still example, at least a part of the stored information is accessed from a computing device remote from the robotic device. In another example, the disposition is periodically generated by the robotic device.

In another aspect, the technology relates to a computing device comprising: at least one processor; and memory encoding computer executable instructions that, when executed by the at least one processor, perform a method. The method comprises: generating, based on input data and output data associated with the computing device, a disposition comprising one or more disposition entries; supplementing at least one disposition entry of the one or more disposition entries based on stored information to generate a supplemented disposition entry, wherein the stored information is at least one of an ontology or memorialized information; evaluating the supplemented disposition entry based on a previously generated disposition to identify one or more changed properties of the supplemented disposition entry; determining, based on a threshold, whether to memorialize a changed property of the supplemented disposition entry; when it is determined to memorialize the changed property, generating memorialized information associated with the changed property; and storing the generated memorialized information. In an example, the method further comprises: generating a behavior for a robotic device based at least in part on the supplemented disposition entry; and causing the robotic device to perform the generated behavior. In another example, supplementing the at least one disposition entry based on stored information comprises: accessing an ontology; determining that the at least one disposition entry is an instance of an object of the ontology; and associating at least one property of the object of the ontology with the at least one disposition entry in the generated disposition. In a further example, supplementing the at least one disposition entry based on stored information comprises: accessing memorialized information; determining that at least a part of the memorialized information comprises historical information relating to the at least one disposition entry; and associating the historical information with the at least one disposition entry in the generated disposition. In yet another example, associating the historical information with the at least one disposition entry comprises associating only a subpart of the historical information, wherein the subpart is determined based at least in part on either: a quantity associated with the historical information; or a time window associated with the historical information. In a further still example, the disposition is periodically generated by the computing device.

In a further aspect, the technology relates to a method for supplementing a generated disposition for a robotic device. The method comprises: generating, based on input data and output data associated with the robotic device, a disposition comprising one or more disposition entries; supplementing at least one disposition entry of the one or more disposition entries based on stored information to generate a supplemented disposition entry, wherein the stored information is at least one of an ontology or memorialized information; generating a behavior for the robotic device based at least in part on the supplemented disposition entry; and causing the robotic device to perform the generated behavior. In an example, the method further comprises: evaluating the generated disposition based on a previously generated disposition to identify one or more changed disposition entries; determining, based on a threshold, whether to memorialize a changed disposition entry of the one or more changed disposition entries; when it is determined to memorialize the changed disposition entry, generating memorialized information associated with the changed disposition entry; and storing the generated memorialized information. In another example, supplementing the at least one disposition entry based on stored information comprises: accessing an ontology; determining that the at least one disposition entry is an instance of an object of the ontology; and associating at least one property of the object of the ontology with the at least one disposition entry in the generated disposition. In a further example, supplementing the at least one disposition entry based on stored information comprises: accessing memorialized information for the robotic device; determining that at least a part of the memorialized information comprises historical information relating to the at least one disposition entry; and associating the historical information with the at least one disposition entry in the generated disposition. In yet another example, associating the historical information with the at least one disposition entry comprises associating only a subpart of the historical information, wherein the subpart is determined based at least in part on either: a quantity associated with the historical information; or a time window associated with the historical information. In a further still example, at least a part of the stored information is accessed from a computing device remote from the robotic device. In another example, the disposition is periodically generated by the robotic device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A robotic device comprising:
at least one processor; and
memory encoding computer executable instructions that, when executed by the at least one processor, perform a method comprising:
generating, based on input data and output data associated with the robotic device, a disposition comprising one or more disposition entries;
supplementing at least one disposition entry of the one or more disposition entries based on stored information to generate a supplemented disposition entry, wherein the stored information is at least one of an ontology or memorialized information;
generating a behavior for the robotic device based at least in part on the supplemented disposition entry; and
causing the robotic device to perform the generated behavior.

2. The robotic device of claim 1, wherein the method further comprises:
evaluating the generated disposition based on a previously generated disposition to identify one or more changed disposition entries;
determining, based on a threshold, whether to memorialize a changed disposition entry of the one or more changed disposition entries;
when it is determined to memorialize the changed disposition entry, generating memorialized information associated with the changed disposition entry; and
storing the generated memorialized information.

3. The robotic device of claim 1, wherein supplementing the at least one disposition entry based on stored information comprises:
accessing an ontology;
determining that the at least one disposition entry is an instance of an object of the ontology; and
associating at least one property of the object of the ontology with the at least one disposition entry in the generated disposition.

4. The robotic device of claim 1, wherein supplementing the at least one disposition entry based on stored information comprises:
accessing memorialized information for the robotic device;
determining that at least a part of the memorialized information comprises historical information relating to the at least one disposition entry; and
associating the historical information with the at least one disposition entry in the generated disposition.

5. The robotic device of claim 4, wherein associating the historical information with the at least one disposition entry comprises associating only a subpart of the historical information, wherein the subpart is determined based at least in part on either:
a quantity associated with the historical information; or
a time window associated with the historical information.

6. The robotic device of claim 1, wherein at least a part of the stored information is accessed from a computing device remote from the robotic device.

7. The robotic device of claim 1, wherein the disposition is periodically generated by the robotic device.

8. A computing device comprising:
at least one processor; and
memory encoding computer executable instructions that, when executed by the at least one processor, perform a method comprising:
generating, based on input data and output data associated with the computing device, a disposition comprising one or more disposition entries;
supplementing at least one disposition entry of the one or more disposition entries based on stored information to generate a supplemented disposition entry, wherein the stored information is at least one of an ontology or memorialized information;
evaluating the supplemented disposition entry based on a previously generated disposition to identify one or more changed properties of the supplemented disposition entry;
determining, based on a threshold, whether to memorialize a changed property of the supplemented disposition entry;
when it is determined to memorialize the changed property, generating memorialized information associated with the changed property; and
storing the generated memorialized information.

9. The computing device of claim 8, wherein the method further comprises:
generating a behavior for a robotic device based at least in part on the supplemented disposition entry; and
causing the robotic device to perform the generated behavior.

10. The computing device of claim 8, wherein supplementing the at least one disposition entry based on stored information comprises:
accessing an ontology;
determining that the at least one disposition entry is an instance of an object of the ontology; and
associating at least one property of the object of the ontology with the at least one disposition entry in the generated disposition.

11. The computing device of claim 8, wherein supplementing the at least one disposition entry based on stored information comprises:
accessing memorialized information;
determining that at least a part of the memorialized information comprises historical information relating to the at least one disposition entry; and
associating the historical information with the at least one disposition entry in the generated disposition.

12. The computing device of claim 11, wherein associating the historical information with the at least one disposition entry comprises associating only a subpart of the historical information, wherein the subpart is determined based at least in part on either:
a quantity associated with the historical information; or
a time window associated with the historical information.

13. The computing device of claim 8, wherein the disposition is periodically generated by the computing device.

14. A method for supplementing a generated disposition for a robotic device, comprising:
generating, based on input data and output data associated with the robotic device, a disposition comprising one or more disposition entries;
supplementing at least one disposition entry of the one or more disposition entries based on stored information to generate a supplemented disposition entry, wherein the stored information is at least one of an ontology or memorialized information;
generating a behavior for the robotic device based at least in part on the supplemented disposition entry; and
causing the robotic device to perform the generated behavior.

15. The method of claim 14, further comprising:
evaluating the generated disposition based on a previously generated disposition to identify one or more changed disposition entries;
determining, based on a threshold, whether to memorialize a changed disposition entry of the one or more changed disposition entries;
when it is determined to memorialize the changed disposition entry, generating memorialized information associated with the changed disposition entry; and
storing the generated memorialized information.

16. The method of claim 14, wherein supplementing the at least one disposition entry based on stored information comprises:
accessing an ontology;
determining that the at least one disposition entry is an instance of an object of the ontology; and
associating at least one property of the object of the ontology with the at least one disposition entry in the generated disposition.

17. The method of claim 14, wherein supplementing the at least one disposition entry based on stored information comprises:
accessing memorialized information for the robotic device;
determining that at least a part of the memorialized information comprises historical information relating to the at least one disposition entry; and
associating the historical information with the at least one disposition entry in the generated disposition.

18. The method of claim 17, wherein associating the historical information with the at least one disposition entry comprises associating only a subpart of the historical information, wherein the subpart is determined based at least in part on either:
a quantity associated with the historical information; or
a time window associated with the historical information.

19. The method of claim 14, wherein at least a part of the stored information is accessed from a computing device remote from the robotic device.

20. The method of claim 14, wherein the disposition is periodically generated by the robotic device.
